(19) United States
(12) Patent Application Publication
(10) Pub. No.: US 2014/0258925 A1
(43) Pub. Date: Sep. 11, 2014

(54) SYSTEM AND METHOD FOR THE VISUALIZATION OF PROPERTIES OF OBJECTS

(71) Applicant: COREL CORPORATION, Ottawa (CA)

(72) Inventors: Claude Peloquin, Gatineau (CA); Neville W. Ko, Nepean (CA)

(73) Assignee: Corel Corporation, Ottawa (CA)

(21) Appl. No.: 13/793,602

(22) Filed: Mar. 11, 2013

(51) Int. Cl. G06F 3/0481

(52) U.S. Cl. CPC G06F 3/0481
USPC 715/808

(57) ABSTRACT

A method includes the steps of: providing a computer readable non-transitory storage medium including a computer readable code configured to run on a computer and to perform a process to visualize a property of objects of a computer drawing; providing a user input device communicatively coupled to the computer; displaying by the computer a list of the properties of the objects in the computer drawing; selecting by the user input device by a hover-over operation a selected property from the list of the properties; and indicating by the computer a marker on the computer drawing at one or more locations of an instance of the objects having the selected property. A system for visualization of a property of objects is also described.

### FIELD OF THE INVENTION

The invention relates to a system and method for the visualization of properties of objects and more particularly to the visualization of properties of objects of a computer drawing.

### BACKGROUND OF THE INVENTION

Drawings can be created on a computer by adding objects to the drawing. The objects can be placed at any location within an available drawing space. Characters of text and shapes are examples of objects that can be added to a drawing.

One or more properties can be assigned to each object. Certain properties are often associated with a given type of object. For example, characters of text can have properties such as attributes of font size and font type. Objects such as rectangles can be assigned properties such as a fill color and a line thickness attribute.

Beyond a small number of objects having a few properties, such computer drawings can quickly include many hundreds or thousands of properties. As the complexity of a drawing grows, there can be many objects which have a same type property. However, even though of the same type, a property can vary, even if only slightly, between objects of a drawing. For example, in a drawing with fifty instances of objects having a color fill property, there could be forty seven instances of one shade of a blue fill color and three instances of a slightly different shade of a blue fill color. All fifty cases are instances of the same type fill property, yet the two shades are two different properties, one property defining a shade of a blue fill color and the other property defining a slightly different shade of blue fill color.

Particularly in more complex drawings, it can be difficult to keep track of which objects have which assigned properties.

### SUMMARY OF THE INVENTION

There is a need for an improved method to more easily identify a property of objects in a drawing.

According to one aspect, the invention features a method including the steps of: providing a computer readable non-transitory storage medium including a computer readable code configured to run on a computer and to perform a process to visualize a property of objects of a computer drawing; providing a user input device communicatively coupled to the computer; displaying by the computer a list of the properties of the objects in the computer drawing; selecting by the user input device by a hover-over operation a selected property from the list of the properties; and indicating by the computer a marker on the computer drawing at one or more locations of an instance of the objects having the selected property.

In one embodiment, the step of providing a user input device includes the step of providing a computer mouse communicatively coupled to the computer.

In another embodiment, the step of selecting by the user input device includes selecting by a mouse hover a selected property from the list of the properties.

In yet another embodiment, the process to visualize a property includes a process to visualize a style, and the list of the properties includes a list of styles, and the selected property includes a selected style, and the instance of the objects having the selected property includes an instance of the objects having the selected style.

In yet another embodiment, the process to visualize a property includes a process to visualize a style set, and the list of the properties includes a list of style sets, and the selected property includes a selected style set, and the instance of the objects having the selected property includes an instance of the objects having the selected style set.

In yet another embodiment, the property includes a color property.

In yet another embodiment, the property includes a shape property.

In yet another embodiment, the property includes a font property.

In yet another embodiment, the list of the properties includes a list of icons representing a property.

In yet another embodiment, the list of icons representing a property includes icons of a color representing a color property.

In yet another embodiment, the list of icons representing a property includes icons of a shape representing a shape property.

In yet another embodiment, the list of icons representing a property includes icons of a font representing a font property.

In yet another embodiment, the step of indicating by the computer a marker includes indicating by the computer a graphical symbol marker on the computer drawing at one or more locations of an instance of the objects having the selected property.

In yet another embodiment, the step of indicating by the computer a marker includes indicating by the computer a color change marker on the computer drawing at one or more locations of an instance of the objects having the selected property.

In yet another embodiment, the step of indicating by the computer a marker includes indicating by the computer an animated marker on the computer drawing at one or more locations of an instance of the objects having the selected property.

In yet another embodiment, the step of indicating by the computer a marker includes indicating by the computer a computer mask superimposed with the computer drawing one or more locations of an instance of the objects having the selected property.

In yet another embodiment, the step of indicating by the computer a marker includes indicating by the computer a re-rendered computer drawing indicating by a modification of one or more pixels one or more locations of an instance of the objects having the selected property.

In yet another embodiment, the step of indicating by the computer a marker includes indicating two or more co-located properties with at least one offset marker.

According to another aspect, the invention features a system which includes a computer configured to run a computer readable non-transitory storage medium including a computer readable code configured to run on a computer and to perform a process to visualize a property of objects of a computer drawing. A user input device is communicatively coupled to the computer. The computer readable code is configured to display by the computer a list of the properties of the objects in the computer drawing, and to select by said user input device by a hover-over operation a selected property from said list of said properties, and to indicate by the computer a marker on the computer drawing one or more locations of an instance of the objects having the selected property.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 shows an example drawing having a list of properties and objects with property markers;

FIG. 2 is an illustration showing markers or hints of nodes;

FIG. 3 is an illustration of a technique to mark an object having a property;

FIG. 4 shows a relatively dense exemplary computer drawing 400 having a number petal shaped objects;

FIG. 5 shows an exemplary computer drawing 500 of five oval shaped objects;

FIG. 6 shows an exemplary computer drawing of five oval shaped objects;

FIG. 7 shows a block diagram summary of an exemplary computer process for the visualization of properties of objects; and

FIG. 8 shows a block diagram of a computer system suitable to perform the process of FIG. 7.

### DETAILED DESCRIPTION

As described hereinabove, by merely viewing a drawing on a computer screen, it can be difficult to see which objects have been assigned a given property. The problem becomes worse when attempting to visually identify objects having a particular property in a drawing that has many objects.

Also, styles can also be assigned to objects. A style is a group of properties that can be assigned to an object. There can also be style sets assigned to an object. A style set is a group of styles that can be applied to the object.

It has been possible to view the properties, styles, or sets of styles of an object by selecting objects one at a time (e.g. by mouse “clicking” on an object). However, such manual searching can be time consuming and is generally inefficient. Another problem with selecting an object is that there is a chance of accidentally changing some aspect of the object, such as by accidentally changing the location of the object on the drawing.

The quantity of objects in a drawing can be relatively high (e.g. hundreds or thousands or more) and the visual variations between similar type properties relatively small (e.g. similar colors or similar font types). The human eye can no longer perceive such small differences across a relatively dense display of a drawing or in many cases, even across a portion of the drawing.

It was realized that an efficient way visualize a property of objects in a drawing is to select a property. Selecting the property, compared with selecting each object one at a time to see what properties have been assigned to it, turns out to be a far more efficient process. A computer process is used since human vision alone, especially when the objects are hidden or partially hidden behind other objects, is inadequate for the visualization of a selected property among many objects or between very similar properties. Visualization as used herein includes computer enhancing a displayed drawing by computer process to show a user the location of a property, style, or style set of one more objects in a drawing. It is thus possible to highlight only the specific parts of a given object that exhibit the property of interest.

One solution to the problem of identifying the use of a particular property in a drawing includes the following steps: select the property, search by computer for objects in the drawing having that property, and display a visual marker on or near each object to which that property has been assigned. The marker can be designed to be easily seen by a human user of ordinary sight. Therefore, for example, a user can see the location, for example, of a few objects having a color fill property of one shade of dark blue in a “sea” of hundreds or thousands of objects having a very slightly different shade of dark blue. While the marker provides a human vision recognizable indication of objects having a selected property, the underlying drawing file remains unchanged, thus preventing accidental changes to the drawing. Another process feature can allow a user to change the property assigned to those objects as a group, however that is an optional feature. This optional feature to change the property of a group of objects can be a second step which can follow the initial identification process. One way to display a visual marker is on an object to which that property has been assigned, including an object that is affected by that property. For example, on the outline or on the fill or on a specific point of a fountain fill (a fill of two or more colors) defined by 3 colors where the highlighted property is only one of the 3 colors of the fountain fill color.

The step of selecting the property can be performed by a user selection from a list of text items. Such selection can be accomplished by clicking on the text of a certain property or on a shape, such as a small box near the text of the property. The list can also take the form of a grouping of icons which each represent a property, such as for example, a group of icons where each icon has a color swatch fill representing a color fill property. The list can be computer generated based on the drawing file so that only properties that can be found in the drawing (or on a portion of the drawing being displayed) are provided as user selections.

It was also realized that a “hover” or “hover-over” operation (also known as “mouse over”) can provide a particularly efficient and user friendly method for the selection of a particular property in a list of properties. In a hover-over operation, a user causes a computer cursor to stay in the vicinity of the bounds of a list item (e.g. a computer cursor moved to substantially over an item). A user can cause the cursor to hover-over or mouse over using any suitable user input device, such as for example, using a computer mouse to hover the cursor over a specific property in a list of properties in order to select a certain property from the list. Once the property has been so selected (e.g. the computer process detects a relatively stable cursor position, such as a cursor within a bounded vicinity of a property in a list of properties for more than a preset threshold of time), the computer process commences to search for that property amongst the objects in the drawing, or in some embodiments, optionally among the subset of objects in a portion of a drawing presently displayed on the computer display screen. It can now be seen that a “selection” can be generated by simply hovering over the representation of a given property (a hover-over operation). The act of “hovering over” generates a temporary selection.

It was also realized that when searching for certain types of properties, it can be more efficient to display a list of graphical items (e.g. a list of icons) either having the property (e.g. a sample of a font property or a color swatch which represents a color fill property), or a graphic image which otherwise readily represents the property to the user. For example, a color property can be offered as a color swatch of that color (or a close facsimile thereof which can be displayed by any giving computer graphics card, graphics mode, and display screen). The color swatch can be presented, for example, as a list or set of small boxes, each box being filled in with a different fill color representing a different color property. Such boxes can be displayed in any suitable arrangement, such as for example, in rows and/or columns, or any combination thereof, in an area of the display over or near the portion of the drawing being viewed or can simply be visible to a user on the same screen or on an adjoining screen in a case of a multiple monitor configuration (dual display, triple display, etc.). For example, the rows and/or columns of boxes can be shown in any suitable display window, sometimes also referred to as a “docker”.

The step of searching objects by computer for the selected property can be accomplished by any suitable computer search as is known in the art. Exemplary suitable search processes include, linear searches where objects in the document are transversed one by one and their properties examined against the one being looked for; dichotomy search where working on a sorted array of object and looking for a property value used to sort the array, the middle element value can be viewed and based on the middle element value look at one half of the array and then continue recursively until matches are found. Indexed searches can also be done where all objects are preprocessed in the background to catalog the objects making later searches perform significantly faster than if no index was used.

Now turning to the step of displaying a visual marker (also, referred to as a “hint”) on or near an object having that property, the marker can be of any suitable shape, style, and color so that it can be seen by a human user of ordinary vision viewing the computer display screen. The location of the marker can be near, in, or superimposed over the object. Size of the object permitting, the marker can be displayed within some bounds of the object itself. In some embodiments, the computer process can further consider the bounds an object to determine a near optimized location for the marker within or near the object. Such a marker location process could also consider the proximity of nearby objects and or the density of objects in that vicinity of the drawing.

As described hereinabove, a marker or a hint can be used for the visualization of a property of one or more objects in a drawing. The same technique can be used to locate a group of properties, otherwise referred to as a style. Similarly, the same technique can be used to locate a group of styles, otherwise referred to as a style set.

### Example 1

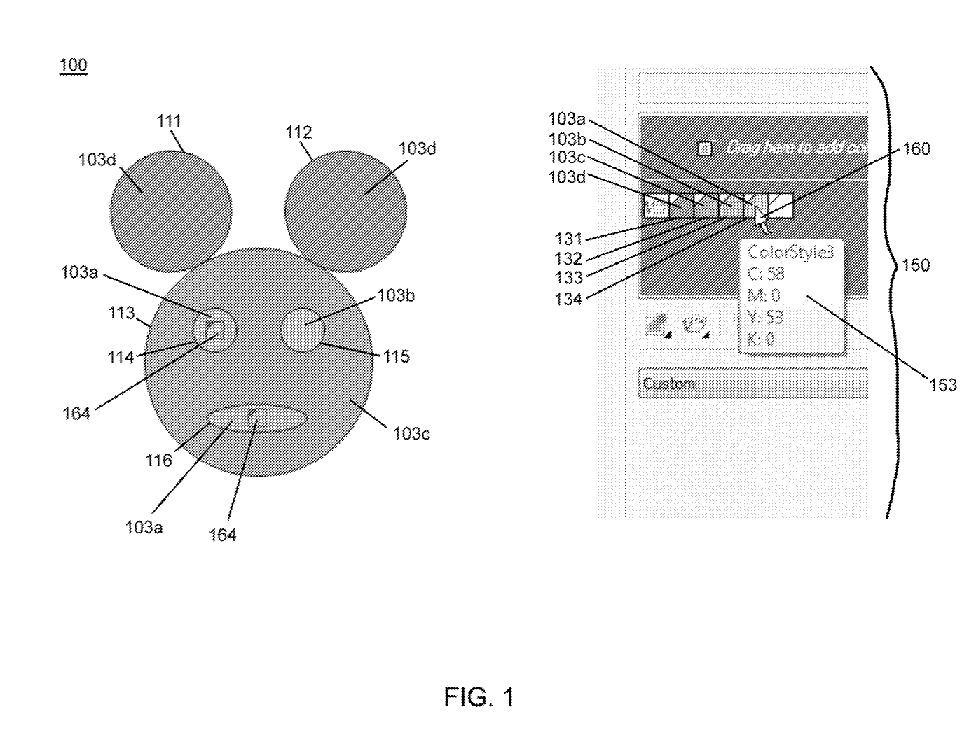

FIG. 1 shows an exemplary drawing 100 having six objects, the objects being represented by outlines. The objects include five circle shaped objects, 111, 112, 113, 114, and 115, and one elliptically shaped object 116. Four shades of a color 103 (e.g. color fills) are represented by color styles 103a, 103b, 103c, and 103d. The four shades of color fill are also displayed in boxes 131, 132, 133, and 134 in a docker 150. In the example, a mouse hover (represented by cursor arrow 160) is shown over box 134. In the example, another feature is shown which opens a small window 153 that shows that the color style 103d of box 134 is named “ColorStyle3” which has the color attributes of C:58, M:0, Y:53, K:0 in a CMYK color model. In the drawing, markers 164 (hints) call visual attention to and show to which objects the ColorStyle3 has been assigned.

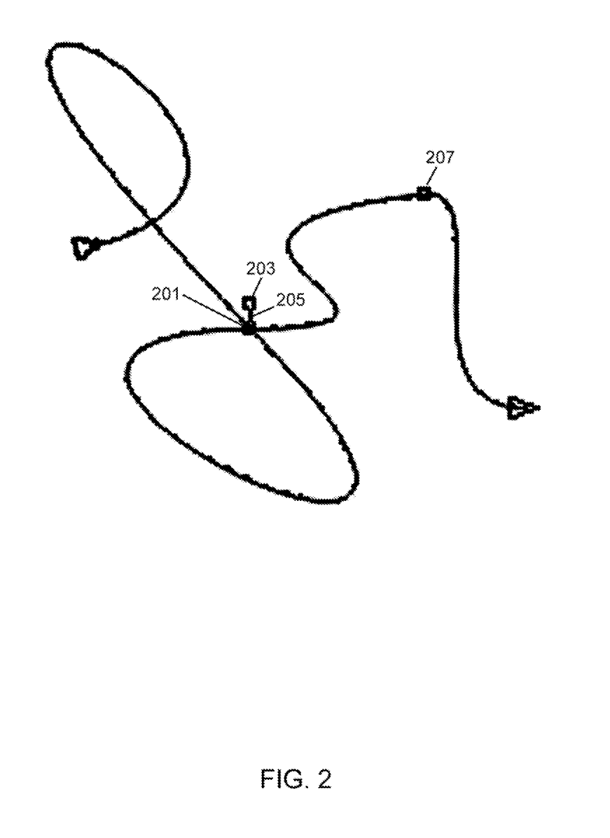

FIG. 2 is an illustration showing exemplary markers (hints) of nodes. Node 207 can be seen on the right side of the drawing as represented by a small box shaped hint. At node 201 there is a second co-located node. To make the co-located node visible, arm 205 extends the hint of node 203 above node 201. This technique of offsetting hints is believed to be generally applicable where multiple markers would otherwise overlap as one.

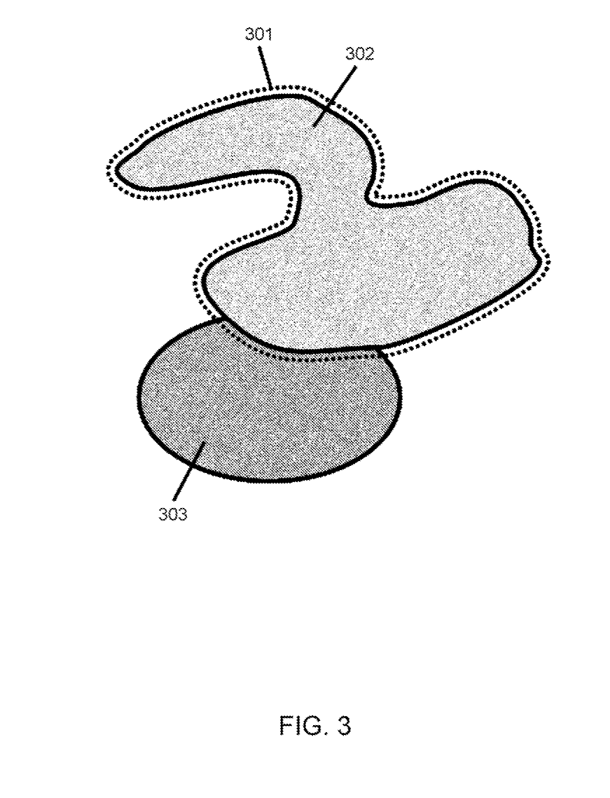

FIG. 3 is an illustration of another exemplary technique useful to mark an object having a property. In FIG. 3, object 302 is marked as having a particular property by the dotted line 301. The dotted line 301 can be seen to not include object 303, which does not have the particular marked property.

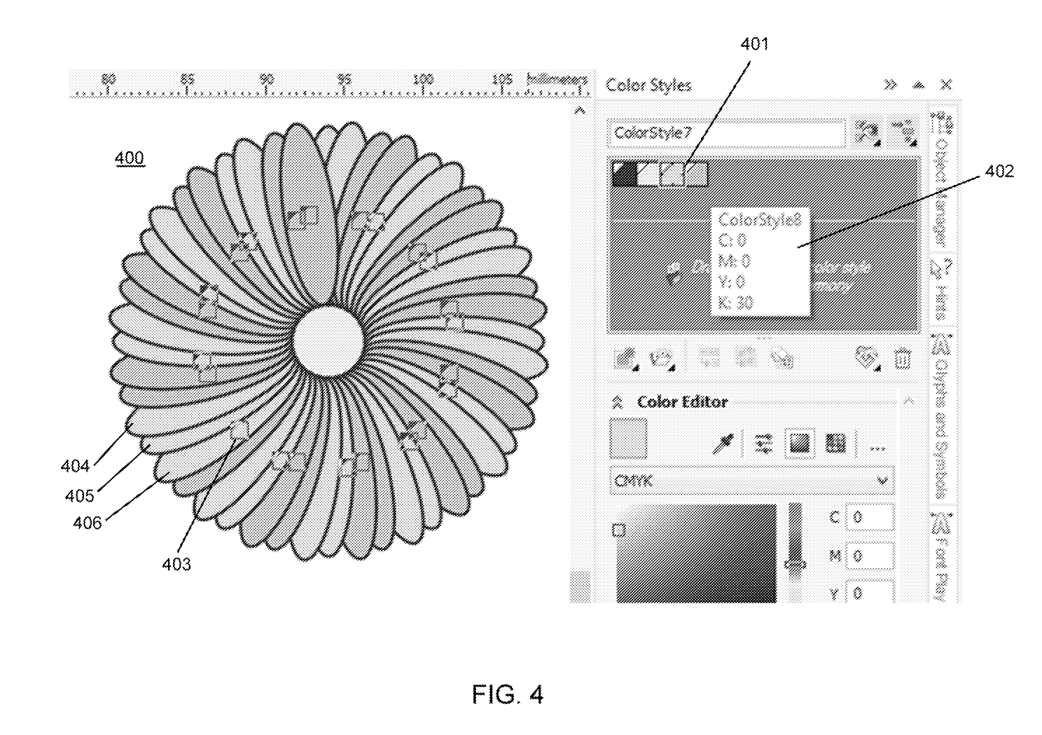

FIG. 4 shows a relatively dense exemplary computer drawing 400 having a number petal shaped objects. A user has performed a hover-over operation over color style 401. An optional pop-up box 402 shows that color style 401 has the color attributes of C:0, M:0, Y:0, K:30 in a CMYK color model. The hint 403 shows that only one of three similarly colored petals of petals 404, 405, and 406 has that color attribute. The user intended petals 404, 405, and 406 to have the same color style 401. In this example, it is only easy to see the color inconsistency in the drawing using the process as described herein.

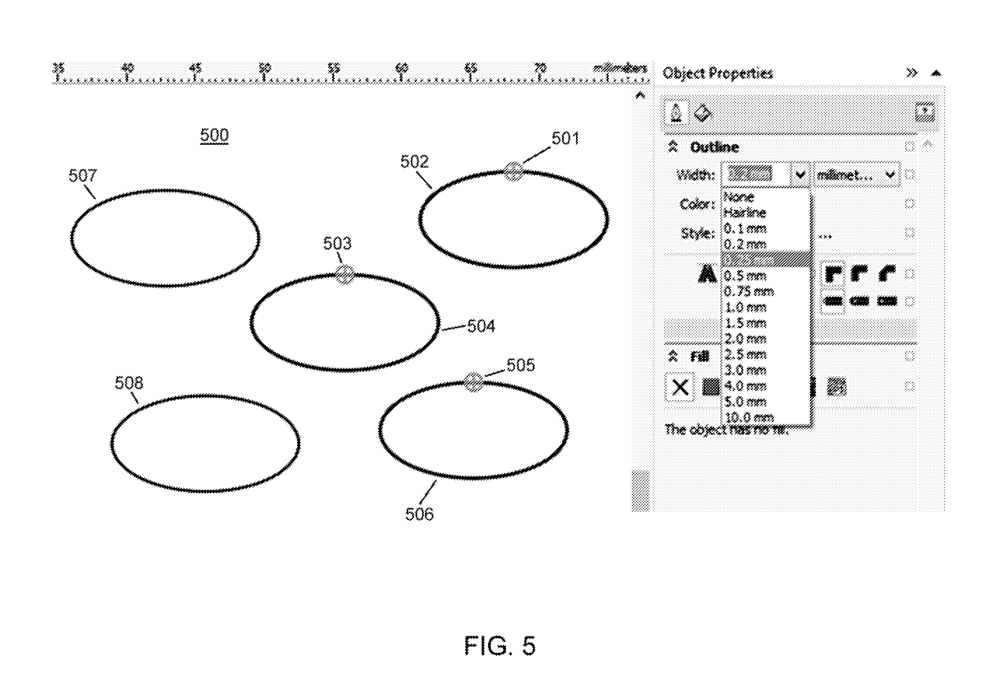

FIG. 5 shows an exemplary computer drawing 500 of five oval shaped objects. Oval shaped object 507 and object 508 have a slightly different line width than oval object 502, oval object 504 and oval object 506. When a hover-over process is performed for a 0.25 mm outline, marker 501, marker 503, and marker 505 immediately show a user that three of the five oval objects have a different line width than the remaining two oval objects. Such markers may be the only way to see such small differences when a drawing is zoomed out.

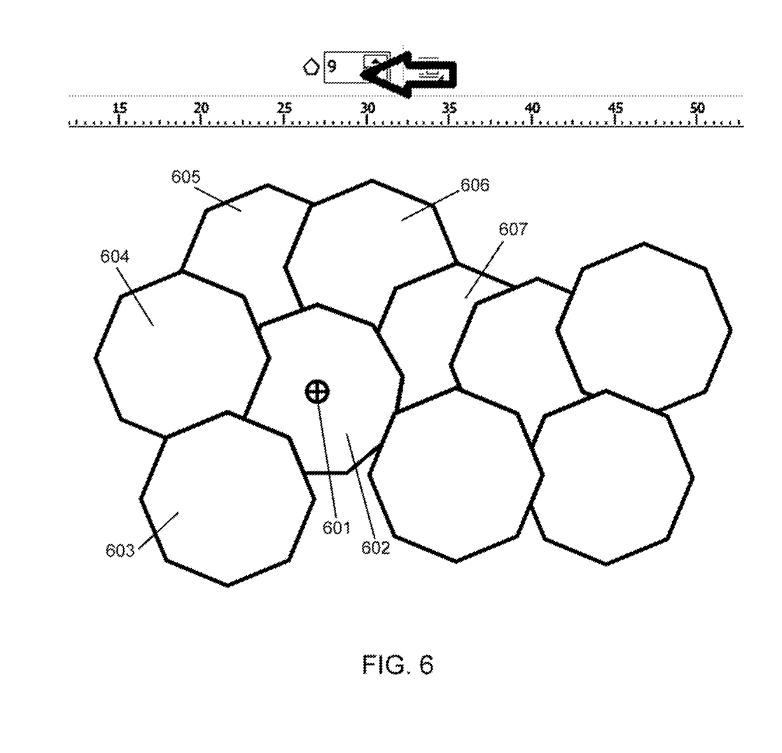

FIG. 6 shows an exemplary computer drawing of five polygon shaped objects. Only one polygon shaped object 602 has a certain property value “9” (nine sides) as indicated by the hint 601 according to the process described herein. Using an embodiment of the inventive technique, polygon shaped objects 603, 604, 605, 606, and 607 can easily be seen as not having nine sides, as they have no visible mark corresponding the hover-over property value 9.

While the marker or hint has been shown hereto as a graphical marker, any suitable attention attracting feature can be used as the hint. For example, the brightness of an object can be dimmed or enhanced (e.g. a “glow” effect). Or, an object could be made to animate (e.g. to shake in an x-y coordinate direction, or to rotate in a shaking way).

While believed particularly advantageous to display a hint as described hereinabove, there are other similar solutions to the problem of efficiently visualizing the properties of objects in a drawing. For example, where color properties are being considered, the color of the objects having the selected color property can be changed to a different color (e.g. an “opposite color” of a color harmony), to make those objects temporarily stand out for easy visual identification. Or, for example in the case of a vector drawing, the drawing can be temporarily re-rendered (e.g. a re-rendered computer bitmap drawing) where the colors of pixels can be changed to show an association with a selected property.

Yet another approach realizes that regardless of the base drawing type (e.g. vector or bitmap), a modern computer screen display of the drawing is typically a pixel based rendering (e.g. a drawing displayed on a LCD pixel based computer monitor). In this approach a drawing mask can be superimposed over the present drawing display where the markers and/or color and/or intensity changes are created by an overlay of the drawing mask and the underlying drawing. Such a drawing mask can also include animation features such as were described hereinabove. The mask approach has an advantage of being able to show pixels that hold a component of a color in question. However, the mask approach can use more computer resources (e.g. run somewhat slower than the other techniques described herein) and in some circumstances, the mask approach is unable to show “hidden objects” using the same color. On the other hand, the mask technique can be useful to visually identify partially visible objects.

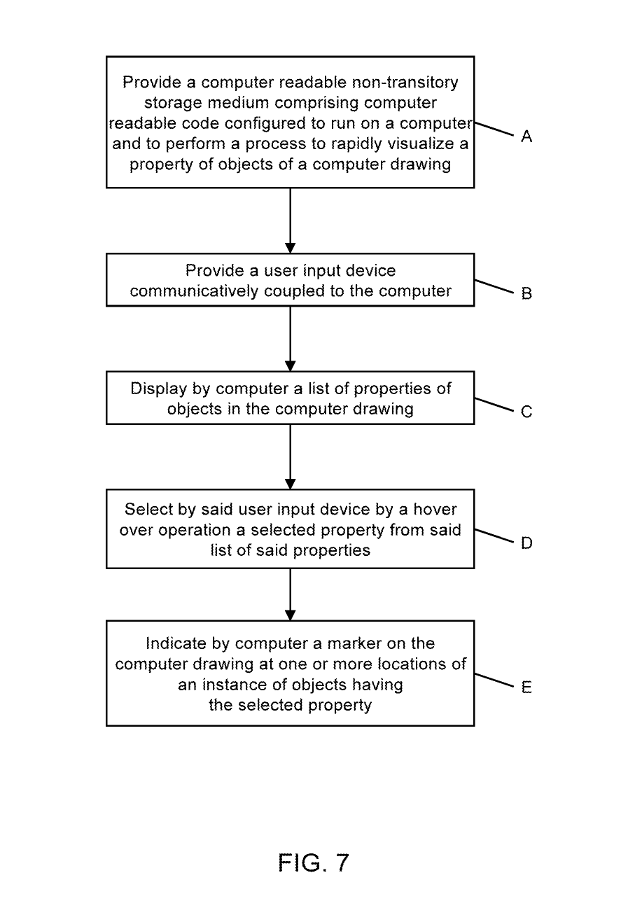

FIG. 7 shows a block diagram summary of one method for the visualization of properties of objects, which includes the steps of: A) providing a computer readable non-transitory storage medium comprising a computer readable code configured to run on a computer and to perform a process to rapidly visualize a property of objects of a computer drawing; B) providing a user input device communicatively coupled to the computer; C) displaying by the computer a list of the properties of the objects in the computer drawing; D) selecting by the user input device by a hover-over operation a selected property from the list of the properties; and E) indicating by the computer a marker on the computer drawing at one or more locations of an instance of the objects having the selected property.

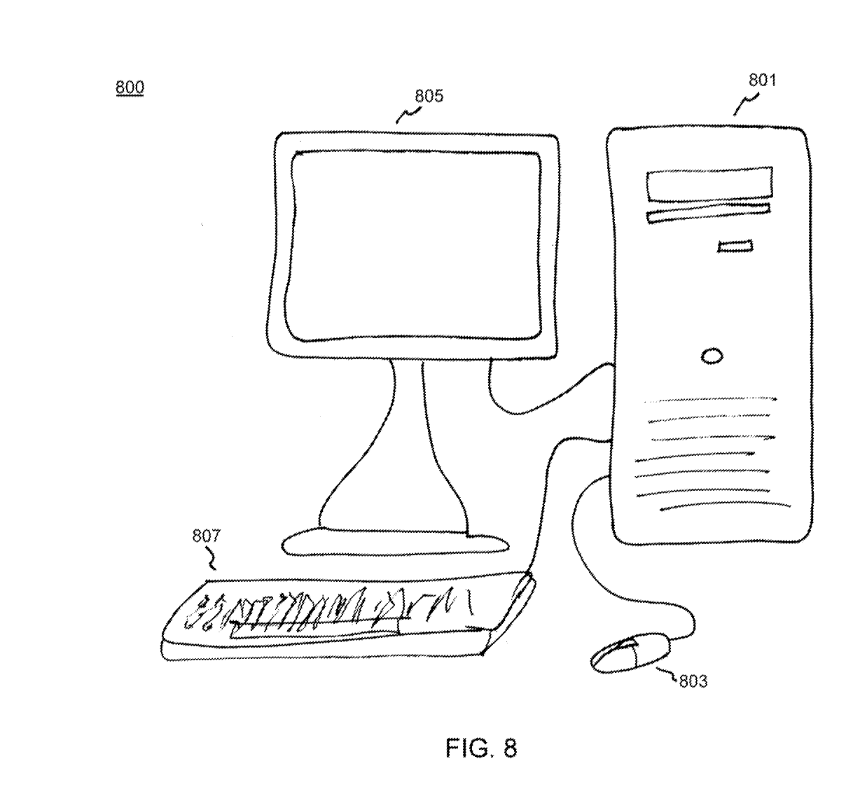

FIG. 8 shows a block diagram of a computer system 800 suitable to perform the process of FIG. 7. Computer 801 has associated with it a user input device 803, such as for example a computer mouse, keyboard 807, and a computer display 805. The computer readable code configured to run on a computer 801 can reside on any suitable computer readable non-transitory storage medium such as for example a CD, DVD, hard drive, solid state drive, etc. (not shown in FIG. 8). A computer suitable to perform the processes described hereinabove can include any suitable type of computer, such as for example, a personal computer having any suitable operating system. It is further contemplated that the inventive processes as described herein can be practiced on any suitable computer based device having a computer processor or firmware which simulates the functions of a computer processor.

In summary, it can now be seen that a computer readable code, as can be typically supplied and/or installed on a computer readable non-transitory storage medium which is configured to run on a computer, can perform a process which allows a user to rapidly visualize a property of objects of a computer drawing. The process provides a visualization of selected properties of objects (including a selected style of objects and a selected style set of objects) by a process of marking, highlighting, or otherwise changing visual attributes of one or more objects in a drawing as displayed, without permanently modifying the drawing file. The process can create a visualization environment where computer generated features such as a marker, a graphical symbol marker, a color change marker, a computer mask (as superimposed over a drawing), an animated marker, and/or a modification of pixel locations (i.e. pixels at certain locations on a displayed image) can draw attention to a property, a style or a style set as can be selected from a list of items. The list of items can be a list of icons.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. A method comprising the steps of:
providing a computer readable non-transitory storage medium comprising a computer readable code configured to run on a computer and to perform a process to visualize a property of objects of a computer drawing;
providing a user input device communicatively coupled to said computer;
displaying by said computer a list of said properties of said objects in said computer drawing;
selecting by said user input device by a hover-over operation a selected property from said list of said properties; and
indicating by said computer a marker on said computer drawing at one or more locations of an instance of said objects having said selected property.

2. The method of claim 1, wherein said step of providing a user input device comprises the step of providing a computer mouse communicatively coupled to said computer.

3. The method of claim 2, wherein said step of selecting by said user input device comprises selecting by a mouse hover a selected property from said list of said properties.

4. The method of claim 1, wherein said process to visualize a property comprises a process to visualize a style and said list of said properties comprises a list of styles and said selected property comprises a selected style and said instance of said objects having said selected property comprises an instance of said objects having said selected style.

5. The method of claim 1, wherein said process to visualize a property comprises a process to visualize a style set and said list of said properties comprises a list of style sets and said selected property comprises a selected style set and said instance of said objects having said selected property comprises an instance of said objects having said selected style set.

6. The method of claim 1, wherein said property comprises a color property.

7. The method of claim 1, wherein said property comprises a shape property.

8. The method of claim 1, wherein said property comprises a font property.

9. The method of claim 1, wherein said list of said properties comprises a list of icons representing a property.

10. The method of claim 9, wherein said list of icons representing a property comprise icons of a color representing a color property.

11. The method of claim 9, wherein said list of icons representing a property comprise icons of a shape representing a shape property.

12. The method of claim 9, wherein said list of icons representing a property comprise icons of a font representing a font property.

13. The method of claim 1, wherein said step of indicating by said computer a marker comprises indicating by said computer a graphical symbol marker on said computer drawing at one or more locations of an instance of said objects having said selected property.

14. The method of claim 1, wherein said step of indicating by said computer a marker comprises indicating by said computer a color change marker on said computer drawing at one or more locations of an instance of said objects having said selected property.

15. The method of claim 1, wherein said step of indicating by said computer a marker comprises indicating by said computer an animated marker on said computer drawing at one or more locations of an instance of said objects having said selected property.

16. The method of claim 1, wherein said step of indicating by said computer a marker comprises indicating by said computer a computer mask superimposed with said computer drawing at one or more locations of an instance of said objects having said selected property.

17. The method of claim 1, wherein said step of indicating by said computer a marker comprises indicating by said computer a re-rendered computer drawing indicating by a modification of one or more pixels one or more locations of an instance of said objects having said selected property.

18. The method of claim 1, wherein said step of indicating by said computer a marker comprises indicating two or more co-located properties with at least one offset marker.

19. A system comprising:
A computer configured to run a computer readable non-transitory storage medium comprising a computer readable code configured to run on a computer and to perform a process to visualize a property of objects of a computer drawing;
a user input device communicatively coupled to said computer; and
wherein said computer readable code is configured to display by said computer a list of said properties of said objects in said computer drawing, and to select by said user input device by a hover-over operation a selected property from said list of said properties, and to indicate by said computer a marker on said computer drawing one or more locations of an instance of said objects having said selected property.
